(19) United States
(12) Patent Application Publication
(10) Pub. No.: US 2009/0114150 A1
(43) Pub. Date: May 7, 2009

(54) Substrate processing apparatus

(75) Inventors: Akihiko Yoneda, Toyama - shi (JP); Kenichi Fujimoto, Nanto-shi (JP)

Correspondence Address: OLIFF & BERRIDGE, PLC, P.O. BOX 320850, ALEXANDRIA, VA, 22320-4850, US

(73) Assignee: HITACHI KOKUSAI ELECTRIC INC., TOKYO (JP)

(21) Appl. No.: 12/289,516

(22) Filed: Oct. 29, 2008

(30) Foreign Application Priority Data
Nov. 5, 2007 (JP) 2007-287841
Aug. 27, 2008 (JP) 2008-218747

(51) Int. Cl. B05C 11/00

(52) U.S. Cl. 118/696; 118/713

(57) ABSTRACT

To simultaneously display a transfer state of substrates (wafers) held on a substrate holding tool and detail-information thereof on the same screen. In a substrate processing apparatus that loads a substrate holding tool, on which a plurality of substrates are placed, into a furnace, and applies prescribed processing thereto, a whole body of boats, as a boat image view of transfer information regarding the substrates on the substrate holding tool, is displayed in an operation screen, and detail-information of a substrate of each area is displayed in the operation screen, with the whole body of the boats divided into a plurality of areas.

### BACKGROUND

1. Technical Field

The present invention relates to a substrate processing apparatus, and particularly relates to the substrate processing apparatus for displaying on a screen a substrate stacking state of a substrate holding tool provided in the substrate processing apparatus.

2. Description of Related Art

Conventionally, in a method of displaying a transfer state of a wafer to a boat, an image of a boat is displayed on a screen, and by classifying wafers by color in a figure of a boat image, the kinds of the wafers on the boat is clarified.

For example, patent document 1 discloses a technique of classifying each wafer on the wafer boat by color according to their kinds, based on slot information of the boat.

### (Patent Document 1)

### Japanese Patent Laid Open No. 11-121586

Conventionally, when processing of deleting the wafer actually having abnormality is performed, for example, it is necessary to switch a screen from the screen of displaying a transfer state of the boat to a setup screen for a wafer transfer device, to give an instruction of operating the wafer transfer device.

However, the screen of confirming a transfer state of the wafer of the whole boats, the screen of confirming detail-information of the wafer, and the screen of deleting the wafer having abnormality are set separately, and therefore usability is not good.

Therefore, an object of the present invention is to display the transfer state of the wafer (substrate) held on the substrate holding tool and detail-information thereof, on the same screen to enable confirmation. Particularly, when the wafer having abnormality is deleted, designation of delete processing and designation of abnormality cancel processing after delete processing are performed on the screen of displaying the transfer state of the substrate and the detail-information of the substrate, and a result thereof is reflected on the screen of displaying the transfer state of the substrate and the detail-information of the substrate.

According to an aspect of the present invention, there is provided a substrate processing apparatus for loading (charging) into a furnace a substrate holding tool, on which a plurality of substrates are placed into a furnace and applying prescribed processing, including: the operation screen which displays a whole body of the boat as a boat image view and transfer information regarding the substrate on the substrate holding tool, wherein the whole body of the boats is divided into a plurality of areas, so that detail-information of the substrate of each area is displayed in the operation screen.

### SUMMARY OF THE INVENTION

According to other aspect of the present invention, there is provided the substrate processing apparatus, for loading into a furnace a substrate holding tool, on which a plurality of substrates are placed, and applying prescribed processing thereto, wherein the whole body of the substrate holding tool is displayed in the operation screen, as a boat image view of transfer information regarding the substrates on the substrate holding tool, and the whole body of the substrate holding tool is divided into a plurality of areas, so that a transfer state of the substrate of each area and break detection result information are displayed in the operation screen.

Further according to other aspect of the present invention, there is provided a substrate processing apparatus for loading into a furnace a substrate holding tool, on which a plurality of substrates are placed, and applying prescribed processing thereto, wherein the whole body of the substrate holding tool is displayed in the operation screen, as a boat image view of transfer information regarding the substrates on the substrate holding tool, so that a recovery state for each substrate having abnormality is displayed in the operation screen.

According to the present invention, the transfer state of the wafer held on the substrate holding tool and the detail-information thereof can be displayed on the same screen. This makes it possible to confirm the transfer state of the wafer and the detail-information of the wafer. In addition, the designation of error processing at the time of the occurrence of abnormality can be performed on the same screen. Therefore, stop of the processing does not occur, by a slight error (simple detection error). Also, error cancellation can be confirmed instantaneously with completion of the error recovery processing, thus improving operation efficiency as a result.

### BRIEF DESCRIPTION OF THE DRAWINGS

FIG. 1 is a perspective view of a substrate processing apparatus according to an embodiment of the present invention.

FIG. 2 is a side perspective view of the substrate processing apparatus shown in FIG. 1.

FIG. 3 is an explanatory view showing a wafer abnormality detection device as an example of a transfer information detection unit according to another embodiment of the present invention.

FIG. 4 is a view showing an example of a controller of a substrate processing system for controlling a plurality of substrate processing apparatuses, according to another embodiment of the present invention.

FIG. 5 is a block diagram showing an example of the controller of the substrate processing system, according to another embodiment of the present invention.

FIG. 6 is a view showing an embodiment of a wafer status screen displayed on the operation screen, according to another embodiment of the present invention.

FIG. 7 is a view showing other embodiment of the wafer status screen according to another embodiment of the present invention.

FIG. 8 is a view showing an example of a recovery command screen according to another embodiment of the present invention.

FIG. 9 is an expanded detailed view showing a detail-display list of FIG. 7.

FIG. 10 is an outline block diagram of an information correction dialog according to another embodiment of the present invention.

FIG. 11 is a schematic view explaining wafer position data detected by a wafer abnormality detection device.

### DESCRIPTION OF PREFERRED EMBODIMENT OF THE INVENTION

In a best mode for carrying out the invention, a vertical substrate processing apparatus (simply called a processing apparatus hereafter) for performing oxidization/diffusion processing and CVD processing to a substrate is selected as a substrate processing apparatus, which is, for example, used as a processing apparatus in a manufacturing method of a semiconductor device (IC).

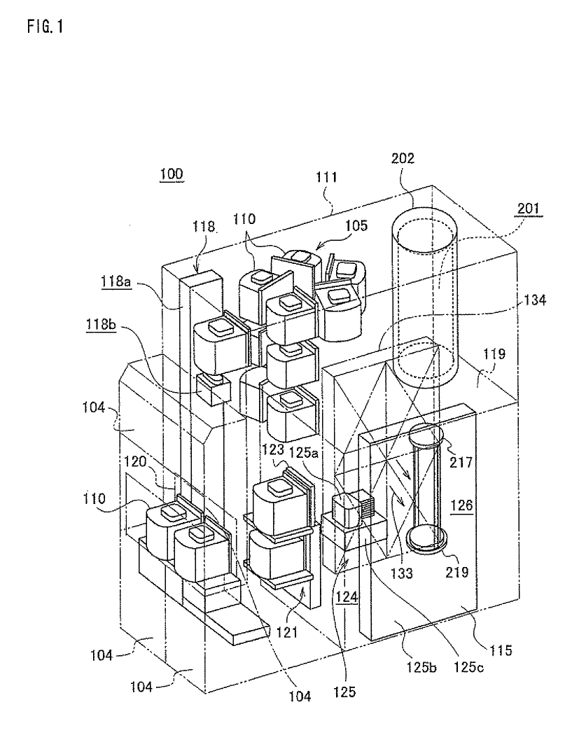

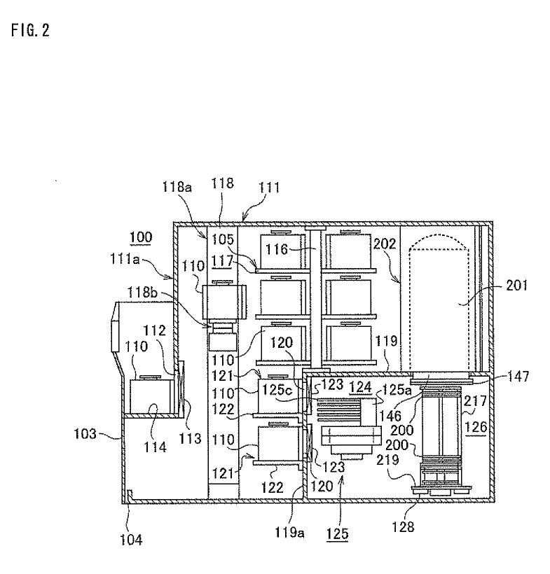

First, explanation will be given for the substrate processing apparatus according to an embodiment of the present invention, with reference to FIG. 1 and FIG. 2.

FIG. 1 is shown as a perspective of the substrate processing apparatus applied to the present invention. Also, FIG. 2 is a side perspective of the substrate processing apparatus shown in FIG. 1.

As shown in FIG. 1 and FIG. 2, FOUP (Front Opening United Pod. Called as pods hereafter) 110, being wafer carriers, are used in a substrate processing apparatus 100. A front maintenance port 103 is opened in front of a front side wall 111a of a casing 111 of the substrate processing apparatus 100, as an opening part for enabling maintenance. Front maintenance doors 104, 104 for opening/closing the front maintenance port 103 are respectively built on this front maintenance port 103.

A pod loading/unloading port (substrate container loading/unloading port) 112 is opened on the front side wall 111a of the casing 111, so as to communicate with inside/outside of the casing 111. The pod loading/unloading port 112 is opened/closed by a front shutter (substrate container loading/unloading port open/close mechanism) 113.

A loading port (substrate container handling stand) 114 is installed in front of the pod loading/unloading port 112. Each pod 110 is placed and aligned on the loading port 114.

The pod 110 is loaded onto the loading port 114 and is unloaded from the loading port 114 by an in-step carrier (not shown).

A rotary pod shelf (substrate container placement shelf) 105 is installed in approximately a longitudinally center part in the casing 111.

The rotary pod shelf 105 is constituted to store a plurality of pods 110. Namely, the rotary pod shelf 105 includes a support 116 vertically erected and intermittently rotated in a horizontal plan surface and a plurality of shelf plates (substrate container placement stands) 117 radially supported by the support 116 at each position of upper/intermediate/lower stages, so that a plurality of pods 110 can be held by each shelf plate 117 in a state of placing each pod 110 thereon.

A pod carrier (substrate container carrier) 118 is installed between the loading port 114 and the rotary pod shelf 105 in the casing 111, and the pod carrier 118 includes a pod elevator (substrate container elevating mechanism) 118a capable of elevating the pod 110 in a state of holding the pod 110 on this elevator, and a pod carrying mechanism (substrate container carrying mechanism) 118b, being a carrying mechanism, and by sequential operation of the pod elevator 118a and the pod carrying mechanism 118b, the pod carrier 118 carries the pod 110 among the loading port 114, the rotary pod shelf 105, and the pod opener (substrate container lid member open/close mechanism) 121.

In a lower part of the casing 111 and in approximately longitudinal center part, a sub-casing 119 is constructed over the rear end. A pair of wafer loading/unloading ports (substrate loading/unloading ports) 120 for loading/unloading the wafer 200 into/from the sub-casing 119 are opened on a front side wall 119a of the sub-casing 119, in a state of being arranged vertically in upper and lower two stages, and a pair of pod openers 121, 121 are respectively installed in the wafer loading/unloading ports 120, 120 of the upper/lower stages.

Each pod opener 121 includes a placement stand 122 for placing the pod 110 thereon, and a cap attaching/detaching mechanism (lid member attaching/detaching mechanism) 123 for attaching/detaching a cap (lid member) of the pod 110. The pod opener 121 opens/closes a wafer charging/discharging port of the pod 110, by attaching/detaching the cap of the pod 110 placed on the placement stand 122, by the cap attaching/detaching mechanism 123.

In the sub-casing 119, a transfer chamber 124 is constituted, so as to be fluidically separated from installation space of the pod carrier 118 and the rotary pod shelf 105. A wafer transfer mechanism (substrate transfer mechanism) 125 is installed in a front side area of the transfer chamber 124, and the wafer transfer mechanism 125 is constituted of a wafer transfer device (substrate transfer device) 125a capable of horizontally rotating and straightly moving the wafer 200, and a wafer transfer device elevator (substrate transfer device elevating mechanism) 125b for elevating the wafer transfer device 125a.

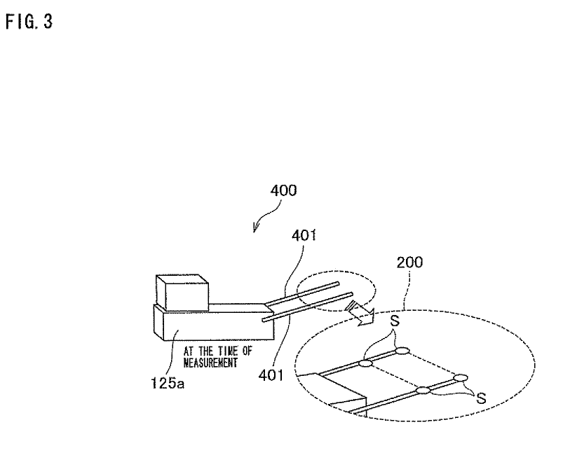

As shown in FIG. 3, a wafer abnormality detection device 400 for detecting a transfer state of the wafer 200 is attached to the wafer transfer device 125a. The wafer abnormality detection device 400 is constituted of, for example, as shown in FIG. 3, a pair of detection arms 401, 401 rotatably attached to both side portions of the wafer transfer device 125a, and an actuator (not shown) for rotary-driving the pair of detection arms 401, 401, and the transfer information of the wafer 200 is detected by a sensor S attached to the pair of detection arms 401, 401. The sensor S is constituted of, for example, a light shielding sensor including a light receiving/emitting sensor.

FIG. 11 is a view for explaining wafer position data detected by the wafer abnormality detection device 400. As is clarified from FIG. 11, the wafer transfer device 125a is moved from lower side to upper side, by driving the actuator, etc, not shown. Then, each position of Bottom, Peak, and Top is sequentially detected from the lower side of the wafer 200, as the wafer position data detected from the wafer abnormality detection device 400 shown in FIG. 3. Note that the boat 217 is not shown.

As schematically shown in FIG. 1, the wafer transfer device elevator 125b is installed between the right side end portion of a pressure-resistant casing 111, and the front area right end portion of the transfer chamber 124 of the sub-casing 119.

By interconnecting movement of these wafer transfer device elevator 125b and wafer transfer device 125a, the wafer 200 is charged and discharged to/from the boat (substrate holding tool), with a tweezer (substrate holding body) of the wafer transfer device 125a set as a placement part of the wafer 200.

A stand-by part 126 for containing the boat 217 and making it stand-by, is constituted on the rear side area of the transfer chamber 124.

A processing furnace 202 is provided in the upper part of the stand-by part 126, and a lower end portion of the processing furnace 202 is opened/closed by a furnace port shutter (furnace port open/close mechanism) 147.

In addition, a boat elevator (substrate holding tool elevating mechanism) 115 for elevating the boat 217 is installed between the right side end portion of the pressure-resistant casing 111 and the right end portion of the stand-by part 126 of the sub-casing 119.

A seal cap 219, being the lid member, is horizontally installed in an arm 128, being a coupling tool coupled to an elevation stand of the boat elevator 115.

The boat 217 is vertically supported by the seal cap 219, so that the lower end portion of the processing furnace 202 can be closed. The boat 217 includes a plurality of holding members having slots for supporting a plurality of wafers 200 in multiple stages, so that a plurality of (for example, about 50 to 200) wafers 200 are horizontally held by the slots of the boat 217 respectively with the wafers 200 arranged vertically with centers thereof aligned.

A clean unit 134 constituted of a supply fan and a dust-proof filter for supplying clean air 133, being cleaned atmosphere or inert gas, is installed on the left side end portion, being the opposite side to the wafer transfer device elevator 125b side and the boat elevator 115 side of the transfer chamber 124, and a notch aligning device 135, being a substrate aligning device for aligning positions of the wafers 200 in a circumferential direction, which is not shown, is installed between the wafer transfer device 125a and the clean unit 134.

The clean air 133 blown out from the clean unit 134 is flown to the notch aligning device 135, the wafer transfer device 125a, and the boat 217 located in the stand-by part 126, then sucked by a duct not shown, and exhausted to outside of the casing 111 or circulated up to a primary side (supply side), being a sucking side of the clean unit 134, and blown out into the transfer chamber 124 by the clean unit 134 again.

Next, explanation will be given for an operation of the substrate processing apparatus 100 according to the present invention, with reference to FIG. 1 and FIG. 2.

When each pod 110 is supplied to the loading port 114, the pod loading/unloading port 112 is opened by the front shutter 113, and the pod 110 on the loading port 114 is loaded into the casing 111 from the pod loading/unloading port 112 by the pod carrier 118.

The loaded pod 110 is automatically carried and transferred to a designated shelf plate 117 of the rotary pod shelf 105 by the pod carrier 118, then temporarily stored therein, and carried and transferred to one of the pod openers 121 from the shelf plate 117, then temporarily stored therein, and carried to the one of the pod openers 121 from the shelf plate 117 and transferred to the placement stand 122 or directly carried to the pod opener 121 and transferred to the placement stand 122.

At this time, the wafer loading/unloading ports 120 of the pod openers 121 are closed by the cap attaching/detaching mechanism 123, and the clean air 133 is flown to the transfer chamber 124 and the transfer chamber 124 is filled with the clean air 133. For example, by filling the transfer chamber 124 with nitrogen gas, being the clean air 133, an oxygen concentration is set to be 20 ppm or less, which is further lower than the oxygen concentration of inside (air atmosphere) of the casing 111.

The pod 110 placed on the placement stand 122 is pushed against an opening edge portion of the wafer loading/unloading port 120 in the front side wall 119a of the sub-casing 119, and the cap thereof is detached by the cap attaching/detaching mechanism 123, and a wafer charging/discharging port is opened.

### (Transfer of the Substrate).

When the pod 110 is opened by the pod opener 121, the wafer 200 are picked up through the wafer charging/discharging port by the tweezer 125c of the wafer transfer device 125a from the pod 110, then after the wafer 200 is aligned by the notch aligning device 135 not shown, the wafer 200 is loaded into the stand-by port 126 located behind the transfer chamber 124, and is charged into the boat 217 (charge).

The wafer transfer device 125a transfers each wafer 200 to the boat 217, then returns to the pod 110 and charges the next wafer 200 into the boat 217.

During charging work of the wafers 200 into the boat 217 by the wafer transfer mechanism 125 in one of the pod openers 121 in (the upper stage or the lower stage), another pod 110 is transferred to the other (the lower stage or the upper stage) pod opener 121 by the pod transfer device 118 from the rotary pod shelf 105, and opening work of the pod 110 by the pod opener 121 proceeds simultaneously.

When the charge of the wafers 200 into the boat 217 is finished, the transfer information is detected by the wafer abnormality detection device 400. At this time, as shown in FIG. 3, the detection arm 401 is inserted into a wafer lower side on the boat 217, and thereafter is sequentially moved to a plurality of wafer break detection points of a lower surface of the wafer, by making the wafer transfer device 125a perform movement such as a rotation around a vertical axis, vertical movement, and movement in all directions. Jump of the wafer 200 is detected by light interception of the sensor S, and appropriateness of the position of the boat slot is detected by a threshold value at the time of the light interception, and the break of the wafer 200 is detected from a comparison in displacement (deflection) at each point or from a relation between the displacement and allowable stress at each wafer break detection point.

When the boat 217 is inserted, the lower end portion of the processing furnace 202 is opened by the furnace port shutter 147 for opening/closing this lower end portion. Subsequently, by elevating the seal cap 219, in which a plurality of wafers 200 are held, by the boat elevator 115, the boat 217 is inserted into the processing furnace 202, so that the wafer 200 is loaded (charged) into the furnace.

After the wafer 200 is loaded, arbitrary processing such as oxidization, film deposition, and diffusion processing are applied to the wafer 200 in the processing furnace 202.

After processing, the wafer 200 and the pod 110 are discharged to the outside of the device, namely outside of the casing 111, in an opposite procedure to the aforementioned procedure, excluding the aligning step of the wafers 200 in the notch aligning device 135 not shown.

In the wafer abnormality detection step after unloading, wafer abnormality namely wafer break is detected, before taking out the already processed wafer 200 from the boat 217.

When the wafer break is detected, the wafer in an abnormal transfer state (called abnormal wafer hereafter) and a peripheral wafer are charged into another carrying vessel different from the pod 110.

Thereafter, normal wafers 200 without break are discharged from the pod 217, and discharged to the outside of the device respectively.

In this embodiment, the wafer abnormality detection step is set to be executed after unloading. However, the present invention is not limited to such a case. For example, the wafer abnormality detection step can be executed after charging the wafer 200 into the boat 217, and before processing the substrate. In a case of setting the wafer abnormality detection step this way, when a carrying error occurs during wafer charge, the wafer break can be detected before the boat 217 is loaded into the processing furnace 202. Therefore, an accident due to the wafer break, for example a loss such as a Lot-Out can be prevented before it occurs. In addition, the wafer abnormality detection step can be performed in both cases after the wafer 200 is charged into the boat 217 and before the wafer 200 is recovered (discharge)from the boat 217 after-thermal treatment. When the wafer abnormality detection step is thus set, the wafer abnormality detection step is executed after the data, being a reference before heat treatment, is acquired and after the heat treatment applied thereto. This makes it possible to perform detection of the wafer break under an optimal condition.

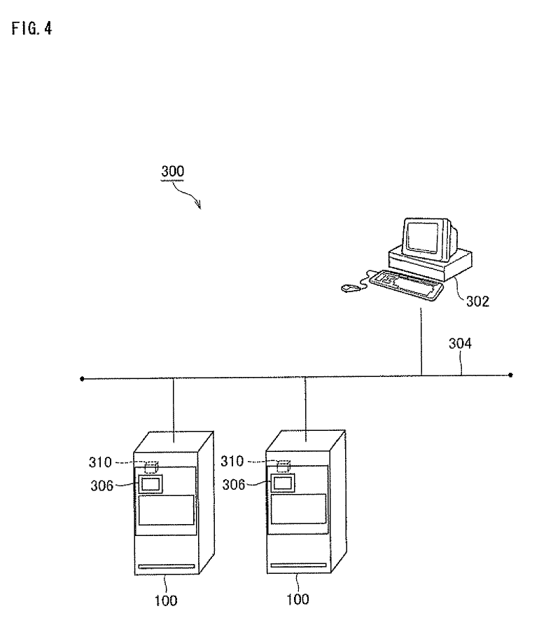

FIG. 4 shows an example of a controller of a substrate processing system 300 that controls a plurality of substrate processing apparatuses 100.

A computer 302 for management or analysis is provided to the substrate processing system 300, and a process module controller (called PMC thereafter) 310 is provided to the substrate processing apparatus 100. The PMC 310 is connected to the computer 302 for management and analysis, via a communication line 304 such as a LAN. Generally, the computer 302 for management performs operation management of a plurality of substrate processing apparatuses 100, and the computer 302 for analysis is used for analyzing data transmitted from the plurality of substrate processing apparatuses 100, and is generally installed outside of a clean room.

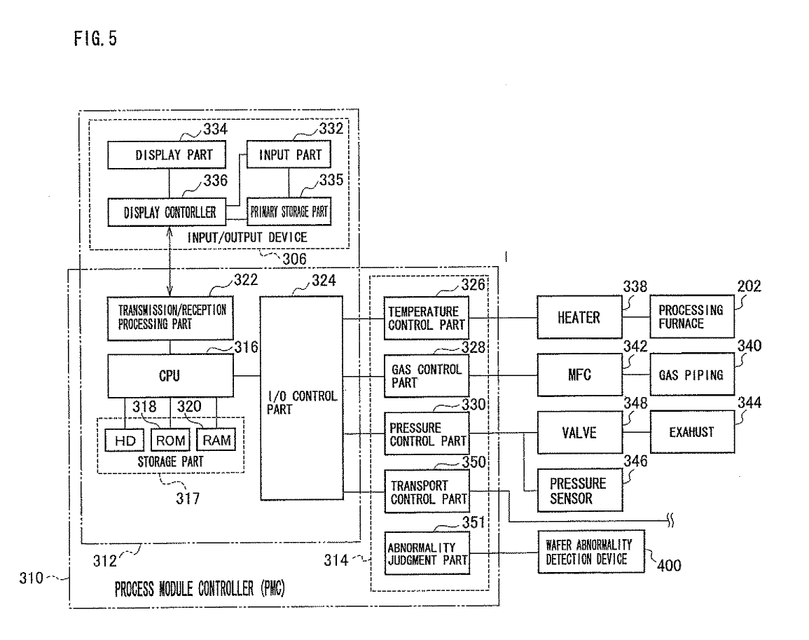

FIG. 5 is a block diagram showing a structure of the controller.

As shown in FIG. 5, the controller includes a main control part 312 and a sub-control part 314, with the main control part 312 including: an input/output device 306; a CPU 316; a storage part 317, being a storing unit; a transmission/reception processing part 322 that performs transmission/reception of data to/from the computer 302 for management or analysis; and an I/O control part 324 that performs I/O control between the CPU 316 and the sub-control part 314. Note that the structure of the computer 302 for management and analysis is approximately the same as that of the main control part 312.

The sub-control part 314 includes a temperature control part 326 that controls temperature in the processing chamber 201 to a substrate processing temperature by a heater (not shown) provided to an outer peripheral part of the processing furnace 202; a gas control part 328 that controls a supply amount, etc, of a reaction gas supplied into the processing furnace 202 based on an output value (detected value of a mass flow controller) from an MFC (mass flow controller) 342 provided to a gas piping 340 of the processing furnace 202; a pressure control part 330 that controls pressure in the processing chamber 201 of the processing furnace 202 to a substrate processing pressure by controlling open/close or opening degree of a valve 348 based on an output value (detected value) of a pressure sensor 346 provided to an exhaust piping 344 of the processing furnace 202; a carrying control part 350 that controls an actuator of a carrying system of the substrate; and an abnormality judgment part 351 that judges the transfer state of the wafer 200 based on the detected value of the wafer abnormality detection device 400. In addition, the abnormality judgment part 351 may be incorporated in the carrying control part 350.

The storage part 317 is constituted of, for example, an ROM (Read Only Memory) 318; an RAM (Random Access Memory) 320; a hard disc HD, and stores recipe and each kind of program, and reference data.

As the reference data, wafer individual information of each wafer 200; wafer kind information, wafer transfer information, and correction information of the wafer transfer state are stored.

Here, the wafer individual information is, for example, lot ID showing lot number of the wafer 200; boat slot No showing a slot insertion position of the pod 110; boat slot No. for inserting the wafer 200 into the designated slot position of the boat 217; and data after edition which is edited using a plurality of information including wafer kind as a kind of wafer.

In addition, the wafer kind information means the data expressing the kind of the wafer, specifically means the data expressing the wafer kind such as a production wafer, a monitor wafer, a side dummy wafer, and a supplementary dummy wafer. The wafer transfer information means the data expressing the transfer state of the wafer 200 on the boat 217 obtained from the individual information of each wafer 200.

Further, the transfer information of the wafer 200 includes the data of a judgment result judged by the abnormality judgment part 351. This data (abnormality data of the wafer 200) is divided broadly into normal or abnormal.

When the transfer state is abnormal, there is the data showing a state or existence of abnormality, such as a state in which insertion depth of the wafer 200 into the slot of the boat 217 is shallow, and the wafer 200 is jumped out from the boat 217 (called wafer jump out hereafter); a state in which break occurs in the wafer 200 (called the wafer break hereafter); a state in which the wafer 200 is inserted not into the slot of the designated boat 217 but into the slot of another boat 217 (called slot difference hereafter); a state in which the wafer 200 is left on the side of the wafer transfer device 125a and the slot of the designated boat 217 is empty (called an empty slot hereafter). In a case of normal, there is the data showing a state of no abnormality.

In addition, the correction information of the transfer state of the wafer 200 means corrected data by amendment out of the transfer data of the wafer 200, in a case of abnormality. The correction of the transfer state is necessary, for making the data on the side of the hardware of the substrate processing apparatus and the data in a system on the side of the controller matched with each other, after the transfer state is recovered by maintenance.

The wafer 200 held by the boat 217 is displayed by differentiating colors, for discriminating the wafer 200 for each kind on the screen, and the transfer state of the normal/abnormal (presence/absence of the abnormality) regarding the wafer 200 held by the boat 217 is displayed on the screen. In addition, when the transfer state is abnormal, the correction information of the wafer transfer state is displayed on the screen by being divided into a state before correction (at the time of abnormality) and a state after correction (after cancel of the abnormality).

The input/output device 306 includes a display part 334 that displays data, etc, stored in the storage part 317; an input part 332 that receives input data (input instruction) of an operator (user) from an operation screen of the display part 334; a temporary storage part 335 that temporarily stores the data until the input data received by the input part 332 is transmitted to the transmission/reception processing part 322 by a display control part 336 as will be described later; and a display control part 336 that receives input data (input instruction) from the input part 332 and transmits this input data to the display part 334 or the transmission/reception processing part 322.

The display control part 336 receives the instruction (execution instruction) to execute an arbitrary recipe of a plurality of recipes stored in the storage part 317 by the CPU 316 via the transmission/reception processing part 322, and the display part 334 displays in the operation screen each kind of display screen necessary for substrate processing, such as selection of recipe; each screen of edition and execution; an execution screen of a command; an execution screen of recovery; and a monitor screen of an operation state of the substrate processing apparatus 100, and displays in the operation screen wafer status screens G1 and G2 as will be described later.

When the recipe prepared and edited in the input/output device 306 is executed in the operation screen, a set value of the recipe is referenced by the sub-control part 314 in an order of each step, and the substrate processing such as oxidization, diffusion, and film deposition processing of the substrate is executed by feedback control of the actuator of a substrate carrying system and a substrate processing system of the substrate processing apparatus.

The carrying control part 350 refers to the wafer identification data (wafer ID) for each wafer 200 previously stored in the storage part 17, when the wafer 200 is transferred to the boat 217 or when the wafer 200 is transferred to the pod 110 from the boat 217, and controls the carrying system of the wafer 200 and the transfer system of the wafer in the wafer transfer device 125a and the boat elevator 115.

The abnormality judgment part 351 judges the transfer state of the wafer 200, based on a result detected for each wafer 200 by the wafer abnormality detection device 400 after processing the wafer 200, and after unloading the boat 217 from the processing furnace 202, or after loading the boat 217 into the processing furnace 202.

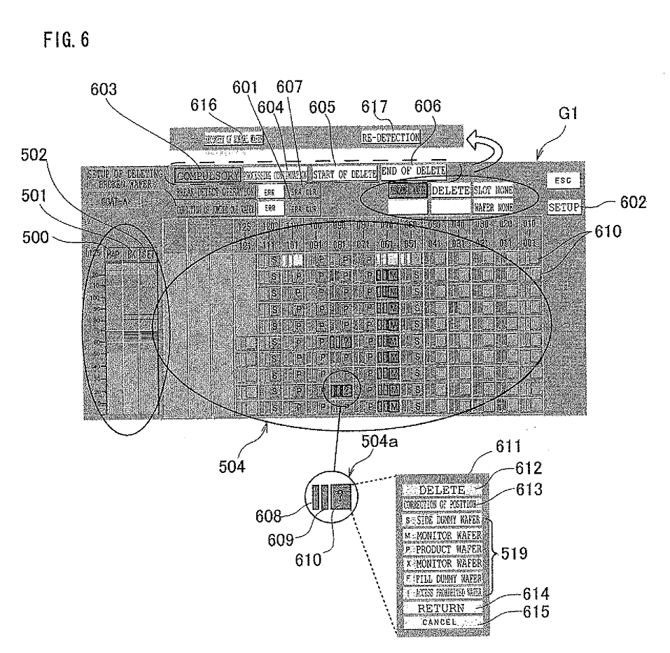

FIG. 6 shows an example of a wafer status screen G1 displayed in the operation screen by the display control part 336.

The kind of the wafer 200 of each wafer 200 on the boat 217, and detailed transfer information of each wafer 200 are displayed on the wafer status screen G1.

In addition, as will be described later, the wafer status screen G1 displays a reference display 519 for referring to the kind and the transfer state of the wafer 200, and also displays a button for performing designation of the processing of deleting broken wafer; designation of the operation for correcting the position of the jumped out wafer; and designation of cancel processing after deleting the broken wafer.

A wafer transfer state (map), wafer detection information, and the correction information of the transfer state are respectively displayed in “Wafer Map” (MAP) 500, “Detect Info.” (BK) 501, and “Info. Correct” (SET) 502, and detail-information of these transfer information is displayed on a detail-information list 504.

The “Wafer Map” 500, “Detect Info.” 501, and “Info Correct” 502 are respectively displayed in the form of a boat image view. These boat image views are displayed on the wafer status screen G1 in the form of a combination of a boat image, being a side image of the boat 217, and a wafer image, being a side image of the wafer 200, or a synthesized image.

In the boat image view of the “Wafer Map” 500, the wafer kind is discriminated by differentiating colors. The wafer image may not be displayed in the slot of the boat 217 on which WAFER NONE 200 is placed. However, the wafer kind is not limited thereto, and it is also preferable that the color showing “WAFER NONE” is designated and is displayed by differentiating color in the same way as the case of the wafer kind.

In the boat image view of the “Detect Info.” 501, a wafer image in a normal transfer state and a wafer image in an abnormal transfer state are discriminated by differentiating colors.

In addition, in the boat image view of the “Info Correct” 502, the wafer image in a normal transfer state requiring no correction, and the wafer image of the correction information in a corrected transfer state by amendment are discriminated by differentiating colors.

Note that in the boat image view of the “Detect Info.” 501, color classification for each wafer kind used in the boat image view of the “Wafer Map” 500 is applied as it is to the wafer image in the normal transfer state, and only the wafer image in the abnormal transfer state may be changed to have the color that can be discriminated. Thus, it is possible to grasp the kind of the wafer in which slot allows the wafer of this kind to be mounted thereon, and in which slot of the boat 217, the wafer 200 in the abnormal transfer state exists.

In addition, in the boat image view of the “Info Correct” 502, color classification of the wafer kind used in the boat image of the “Wafer Map” 500 is applied as it is to the wafer image in the normal transfer state, and the color of the wafer image after correction may be changed to the color that can be discriminated from other color. Thus, in the boat image view of the “Info Correct” 502, the kind of the wafer 200, the transfer state and correction of the transfer state of the wafer 200 are clearly grasped. In addition, the “WAFER NONE” shows a case in which the wafer 200 is not inserted into the slot of the boat 217 from the first. Further, it is also preferable that the wafer image in the abnormal transfer state used in the boat image view of “Detect Info.” 501 is applied as it is, and the color of the wafer image after correction that has undergone processing of deleting abnormality may be changed to the color that can be discriminated from other color. This makes it easier to grasp the progress of the recovery processing of the abnormal wafer.

The correction of the wafer transfer state is executed after the maintenance of the abnormal wafer is executed by an operator.

The display control part 336 updates transfer information stored in the storage part 17, when the transfer state is corrected.

When the correction of the transfer state on the boat 217 is thus executed after the maintenance of the operator is executed, the data of the transfer state is matched between the hardware side of the substrate processing apparatus 100 and the software side of the substrate processing system. Therefore, it is possible to solve mismatch between actual transfer information of the boat 217 thereafter, and the data on the system.

The detail-information list 504 is constituted of a plurality of detail-displays 504a.

The detail-display 504a is provided in each wafer (or in each slot of the boat 217), and each one is constituted of a normal map state display (wafer kind information) 608, a wafer state display 609 (wafer abnormality information), and a state correction button (correction information of the wafer transfer state) 610, which are disposed in an arrangement in an order of boat slot number below display segments set on the wafer status screen G1, such as “001-010”, “011-020”, . . . , “121-125”. Note that numbers in “ “ of each segment show the slot number of the boat 217, respectively.

Usually, display color of the normal map state display 608 is determined based on a state such as WAFER NONE (having slots), the kind of the wafer 200, and a state such as others (no slots), and display colors of the wafer state display 609 and the state correction button 610 are determined based on a state such as WAFER NONE (having slots), the wafer kind, the kind of the wafer such as an abnormal wafer, a deleted wafer, an access prohibited wafer, and a state such as others (having no slots).

In addition, symbols such as “S”, “P”, “M”, “?”, “!” corresponding to the kind of the wafer and the kind of the abnormal wafer are displayed on the surface of the state correction button 610.

In the case of the abnormal wafer, namely, in the case of a broken wafer and a jumped out wafer, the display color and the symbol of the abnormal wafer are used for the display color and the symbol of the state correction button 610.

Note that “S” shows a side dummy wafer, “P” shows a product wafer, “M” shows a monitor wafer, “?” shows an abnormal wafer, and “!” shows an access prohibited wafer.

In addition, the state correction button 610 is linked to an execution program, and by depressing this state correction button 610, a pop up window 611 is displayed, for correcting the wafer transfer information before correction, being a detection result of the wafer abnormality detection device 400, so as to correspond to the result of the maintenance executed for the abnormal wafer.

A “DELETE” button 612 and a “POSITIONAL CORRECTION” button 613 are displayed in the pop up window 611, as correction buttons.

The “DELETE” button 612 is linked to an execution program, and by depressing this “DELETE” button 612, the display color of the state correction button 610 is changed, in such a manner that red is changed to the display color of WAFER NONE such as white, and further the symbol of the abnormal wafer on the surface of the state correction button 610 is changed, in such a manner that “?” is changed to no symbol display corresponding to the state of WAFER NONE.

The state of the “WAFER NONE” is the state in which no wafer 200 is inserted into the slot. Namely, by depressing the “DELETE” button 612, as a result of the maintenance executed for the broken wafer, namely, the delete of the wafer placed on the slot with broken wafer generated, and the display of the state correction button 610 corresponding to this slot can be made identical to each other.

In addition, the “POSITONAL CORRECTION” button 613 is also linked to the execution program, and by depressing this button, the display color of the state correction button 610 is changed in such a manner that red is changed to the display color of WAFER NONE, for example changed to white, and further the symbol of the abnormal wafer assigned to the surface of the state correction button 610 is changed, for example “?” is changed to the symbol of the wafer kind display such as “S”.

Namely, as a result of the maintenance executed for the jump out of the wafer, namely, retry processing of the wafer placed on the slot, with jump out of the wafer generated, and the display of the state correction button 610 corresponding to this slot are made identical to each other.

Further, the display color of the wafer state display 609 is changed in conjunction with the change of the display color of the state correction button 610. Therefore, by depressing the state correction button 610, the display color of the abnormal wafer of the wafer state display 609 can be changed to the display color of WAFER NONE, by correcting the wafer transfer information.

Note that a “RETURN” button 614 and a “CANCEL” button 615 are displayed in the pop up window 611. The “RETURN” button 614 is the button for ending the pop up window 611 to return to the original wafer status screen G1, the “CANCEL” button 615 is the button for canceling the correction by the “DELETE” button 612 and the “POSITIONAL CORRECTION” button 613.

The reference display 519 is displayed so as to be divided into, for example, the wafer status screen G1 and the pop up window 611 by the aforementioned display control part 336. In the pop up window 611, reference information regarding the kind of the wafer such as “S: side dummy wafer”, “M: monitor wafer”, “P: product wafer”, “X: monitor wafer”, “F: dummy wafer”, “!: access prohibited wafer” is displayed in the form of buttons or cells. In the wafer status screen G1, the reference information regarding the wafer transfer state such as “?: abnormal wafer” and “!: access prohibited wafer” is displayed.

Such reference information is displayed by differentiating colors based on the kind of the wafer and the kind of the wafer transfer state.

Also, in the wafer status screen G1, a button (as will be described later) for designating the operation for recovery of the broken wafer and correcting the position of the jumped out wafer, for designating cancel processing after deleting the broken wafer, and for reflecting its result on the screen; “ERROR CLR” button 601 for canceling error; and a “SETUP” button 602 for determining the operation of these buttons, are displayed.

The abnormal wafer DELETE button is constituted of a “COMPULSORY” button 603, “PROCESSING CONTINUATION” button 604, a “START OF DELETE” button 605, and an “END OF DELETE” button 606.

The “COMPULSORY” button 603 is the button for executing discharge of the wafer 200 by using the wafer transfer device 125a; the “PROCESSING CONTINUATION” button 604 is the button for canceling pause of the wafer transfer device 125a; the “START OF DELETE” button 605 is the button for executing the operation of deleting the broken wafer by using the wafer transfer device 125a; the “END OF DELETE” button 606 is the button for enabling the correction of changing the transfer information of the slot of the boat 217, with broken wafer deleted, to an empty slot (WAFER NONE) on the wafer status screen G1.

The “SETUP” button 602 is the button for determining the setup regarding the deleted broken wafer and the setup regarding cancel of the error such as jump out of the wafer.

The “ERR CLR” button 601 is the button for recharging the jumped out wafer to a normal position of the slot of the boat 217 by using the wafer transfer device 125a.

The “ERR CLR” button 607 is a break detecting operation error cancel button. This button 607 performs error canceling when wafer break detecting operation ends abnormally.

The result of these button operations are displayed in the status screen G1 as “break detecting operation” and “jump out state”.

In the display of the “break detecting operation”, the result of the wafer break detecting operation is displayed in the cell at the left side of the “ERR CLR” button 607, by “OK” or “ERR”. “OK” shows that the wafer break detecting operation ends normally, and “ERR” shows that the wafer break detecting operation ends abnormally.

When the “ERR” is displayed, the break detection error cancel button 607 is displayed as “ERR CLR” at the side of the cell displaying “ERR”, and when the “OK” is displayed, “NOP” is displayed.

The display of the “ERR CLR” and “NOP” is thus selectively displayed based on a detection result of the wafer abnormality detection device 400.

In the display of the “jump out state”, the result of the jump out of the wafer is displayed by “OK” or “ERR”. “OK” shows that there is no jump out of the wafer 200, and “ERR” shows that there is jump out of the wafer 200.

When the “ERR” is displayed, jump out error cancel button 601 is displayed as “ERR CLR” at the side of the cell displaying “ERR”. In addition, when “OK” is displayed, “NOP” is displayed at the side of the cell displaying “OK”. The display of “ERR CLR” and “NOP” is thus selectively displayed based on a detection result of the wafer abnormality detection device 400.

When the “ERR CLR” button 601 is depressed, an error cancel instruction is outputted to the wafer transfer device 125a.

Note that when the abnormal wafer is generated, a designation button of the wafer is omitted in this example. However, it is also possible that either one of the “setup” button 602 and the state correction button 610 is set as a shift key, and the wafer is designated by combination of them.

Next, explanation will be given for an example of a procedure of discovery of abnormality, and an example of a procedure of performing designation of the processing after detecting the abnormal wafer by the wafer abnormality detection device 400 and the designation of cancel processing after deleting the this wafer, then displaying this result on the wafer status screen G1, with the transfer state of the substrate and the detail-information of the substrate displayed thereon.

When the abnormal wafer is generated, in the boat image view of the “Detect Info.” 501 and “Info Correct” 502, the color of the wafer image of the abnormal wafer shows a specific color of the abnormal wafer referenced by the reference display 519, such as a thick color.

For example, in FIG. 6, in the “Detect Info.” 501, the color of the wafer image of slot No. 60 to 70 becomes the color of the abnormal wafer. Also, regarding the same slot No, the colors of the wafer state display 609 (wafer transfer information) and the state correction button 610 of the detail-information list 504 become the same color as the color of the abnormal wafer.

Accordingly, it is found from these results, that there exist a plurality of abnormal wafers in the boat 217.

Next, when the symbol assigned to the state correction button 610 is observed, it is found that the symbol of “?” is assigned to the state correction button 610 of the slot No. 80 and slot No. 85, while the symbol “M” is assigned to the state correction button 610 of the slot No. 60 to 70. Therefore, when the state correction button 610 is depressed and the pop up window 611 displayed on the wafer status screen G1 is referenced, it is found that “M” is the monitor wafer.

Here, the combination of the color of the abnormal wafer and “?” means the broken wafer, and “M” and “S” mean the kind of the wafer. Therefore, it is found that in the slots of the slot No. 80 and slot No. 85, the wafer break (the break of the wafer) is generated, and in each slot of the slot No. 60 to 70, the wafer jump out (the jump out of the wafer) is generated in the monitor wafer.

When the abnormal wafer is discovered, maintenance operation is performed from the wafer status screen G1, for solving the wafer break and the wafer jump out.

### <Regarding the Maintenance of the Wafer Break>

### <Case of Previously Recovering the Broken Wafer>

The “COMPULSORY” button 603, the “PROCESSING CONTINUATION” button 604, the “START OF DELETE” button 605, and the “END OF DELETE” button 606 are used when the broken wafer is previously recovered by opening a device backside door by a worker and a remaining normal wafer is recovered by the wafer transfer device 125a.

When the wafer break is generated, first, the “START OF DELETE” button 605 is depressed, to make a state capable of deleting the broken wafer. The state capable of deleting the broken wafer means the state in which the broken wafer placed on the boat, can be deleted by opening the device backside door by the worker. After the broken wafer is deleted, the worker closes the device backside door and depresses the “END OF DELETE” button 606. When the “END OF DELETE” button 606 is depressed, the boat on which the normal wafer is mounted, is moved to a position capable of being recovered by the wafer transfer device 125a. The worker performs correction of the wafer information of the broken wafer recovered manually by the worker. Thereafter, when the “PROCESSING CONTINUATION” button 604 is depressed, the detection operation of the wafer break is re-executed. When the “COMPULSORY” button 603 is depressed, the normal wafer is recovered by the wafer transfer device 125a. Thus, the maintenance of the broken wafer is ended.

### <Case of Previously Recovering the Normal Wafer>

A “NORMAL WAFER RECOVERY” button 616 and a “RE-DETECTION” button 617 are used when the broken wafer is manually recovered by opening the device backside door by the worker, after the normal wafer is recovered by the wafer transfer device 125a.

When the wafer break is generated, first, the “NORMAL WAFER RECOVERY” button 616 is depressed, and the normal wafer is recovered by the wafer transfer device 125a. After the normal wafer is recovered, by opening the device backside door, the worker manually recovers the broken wafer. After the broken wafer is deleted, the worker closes the device backside door. Thereafter, correction of the wafer information is performed to the manually recovered broken wafer.

The wafer break state on the boat is confirmed and when there is no abnormal wafer, the “RE-DETECTION” button 617 is depressed.

Note that when the detection operation of the wafer break is ended abnormally during maintenance, the “ERR CLR” button 607 displayed at the side of the “BREAK DETECTING OPERATION” to cancel the error, and thereafter the broken wafer is deleted by repeating the aforementioned operation procedure.

When the recovery of the broken wafer is ended, subsequently, the data at the hardware side and the system side of the substrate processing apparatus are made coincident to each other. In this case, first, by depressing the state correction button 610, the pop up window 611 is displayed on the wafer status screen G1.

At this time, the color of the state correction button 610 to be depressed remains to be red, before the broken wafer is recovered.

When the “DELETE” button 612 of the pop up window 611 is depressed, the colors of the state correction button 610 and the wafer state display 609 are changed to the color of WAFER NONE from red, such as white color.

When the change of the color of the state correction button 610 and the wafer state display 609 are confirmed, next, the “SETUP” button 602 of the wafer status screen G1 is depressed, to confirm this change.

Thus, the colors of the state correction button 610 and the wafer state display 609 are confirmed to be white, and in conjunction therewith, the color of the wafer image of the broken wafer of the “Info Correct” 502 is changed to the same white.

### <Regarding the Maintenance of the Wafer Jump Out>

In this case, the wafer jump out state on the boat is confirmed. When there is the wafer in a jump out state, the worker corrects the jump out state of the wafer by opening the device backside door. Thereafter, by depressing the “RE-DETECTION” button 617 or the “PROCESSING CONTINUATION” button 604, the detecting operation of the wafer break is re-executed.

When there is no wafer in a jump out state, the “RE-DETECTION” button 617 or the “PROCESSING CONTINUATION” button 604 are depressed to re-execute the detection operation of the wafer break.

Note that from the display of the “Info Correct” 502 and the detail-display 504a, it is found that the wafer is not inserted into the slots of slot No. 110 and slot No. 70, and the state is set as NO SLOT, also there is no slot on the boat 217 after slot No. 126, namely, the wafers up to 125 sheets can be inserted, and also side dummy wafers are inserted into the slots of the slot No. 51 to 60, and product wafers are inserted into the slots of the slot No. 71 to 109, and the side dummy wafers are inserted into the slots of the slot No. 111 TO 120, in a state of no trouble (no abnormality).

Therefore, according to the aforementioned wafer status screen G1, it is possible to confirm the kind of the wafer 200 and an insertion position on the boat 217, and further presence/absence of the abnormal wafer and the slot thereon, on the same screen, and in addition possible to recover the abnormal wafer by depressing the button in the operation screen or correct a slot insertion position. This makes it possible to largely improve the usability.

However, when boat image views of the Wafer Map (Map) 500, Detect Info. (BK) 501, and Info Correct (SET) 502, and the detail-display 504a of 1 to 160 (1 to 200 in some cases) are displayed on the same wafer status screen G1, characters and symbols become smaller, thus limiting display contents that can be displayed in each one of the detail-display 504a, resulting in a screen difficult to be grasped by the operator.

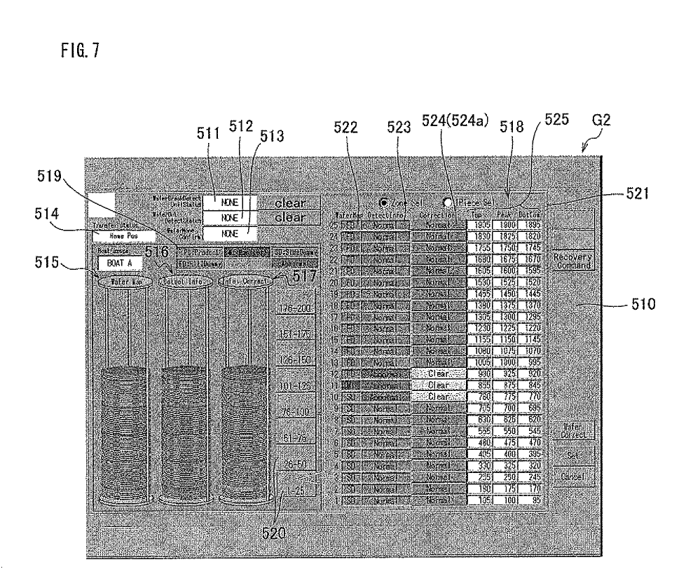

FIG. 7 shows an improved wafer status screen G2, in view of the above-described circumstance.

This wafer status screen G2 is also prepared based on wafer individual information of each wafer 200, wafer kind information for the display by differentiating colors, wafer transfer information and correction information of the wafer transfer state stored in the aforementioned storage part 17 in the same way as the wafer status screen G1, and is displayed in the operation screen by the aforementioned display control part 336.

In addition, the wafer status screen G2 is displayed on an operation panel 510.

In this wafer status screen G2, “Wafer Map” 515, “Detect Info.” (detection information) 516, “Info Correct” (correction information) 517, detail-information display 518, and reference display 519 are displayed.

These “Wafer Map” 515, “Detect Info.” (detection information) 516, “Info Correct” (correction information) 517 are displayed as the boat image views closer to the boat 217 on the screen, compared with the wafer status screen G1. However, detailed explanation is omitted here, because the structure and the function are the same. In addition, a boat usage is designated as “Boat A”. For example, in the operation by 2 boat SPEC, the boat 217 can be selected here.

The reference display (wafer kind and the transfer state display) 519 is disposed in the upper part of the screen of the wafer status screen G2, including a plurality of cells for displaying the kind of the wafer 200, and characters and symbols for referencing the color of each cell.

In the example shown in the figure, a production wafer (PD) is referenced by the color of “lightseagreen” and “PD: Product”, and a monitor 1 wafer (M1) is referenced by the color of “mediumslateblue” and “M1:Monitor1”. In addition, the side dummy wafer (SD) is referenced by the color of “andybrown” and “SD:SideDUMMY”, also supplementary dummy wafer (FD) is referenced by the color of “mediumpurple” and “FD: FillDummy”, and the abnormal wafer is referenced by the color of “darksalmon” and “Abnormal”.

One detail-display 520 is allocated to each display section of the boat slot obtained by dividing the number of boat slots of the boat 217 by prescribed number.

In this embodiment, one detail-display button 520 is respectively allocated to eight display sections “1-25”, “26-51”, . . . , “176-200”. The detail-display button 520 is displayed in approximately the center of the screen in parallel to the boat image and in the same vertical arrangement as the boat slot No. of the boat 217. Then, these detail-display buttons 520 are constituted so as to display on the wafer status screen G2, a list (called detail-display list hereafter) 521 of the transfer information of the wafer 200 of the allocated display section, by being depressed.

Therefore, for example, when the detail-display button 520 of “1-25” is depressed, the detail-display list 521 of the wafer 200 inserted into the slot of the slot numbers 1 to 25 of the boat 217 is displayed on the wafer status screen G2, and when the detail-display button 520 of “176-200” is depressed, the detail-display list 521 of the wafer 200 inserted into the boat slot of the slot number 176-200 of the boat 217 is displayed on the wafer status screen G2.

The detail-display list 521 is displayed on the same screen as the boat image view, with a display line of the detail-display buttons 520 sandwiched between them.

The detail-display list 521 is constituted of a table form of n rows and m columns, and is constituted of the number corresponding to the boat slot number and each cell displaying detailed data of “Wafer Map”, “Detect Info.”, “Correction”, “Top”, Peak”, “Bottom”.

In the detail-display list 521, in the same way as the “Wafer Map” 515, “Detect Info.” 516, “Info. Correction” 517, color classification is applied to the “Wafer Map” cell 522, “Detect Info.” Cell 523, “Correction” cell 524, based on the wafer kind information and the wafer transfer information and the correction information of the wafer transfer state in the storage part 17.

In the “Wafer Map” cell 522, the same character symbol or abbreviation as that of the reference display 519 such as “FD”, “M1”, “M2”, “PD”, “SD” are displayed, and in the “Detect Info.” Cell 523, for example, “Normal” or “Abnormal” is displayed as the detail-information of the kind of the wafer, and in the “Correction” cell 524, for example, space “(“Clear” is used in the meaning of (blank”). Buttons that can be depressed are formed in each “Correction” cell 524. In this case, “Normal” in the “Detect Info.” Cell 523 and the “Correction” cell 524 means that the wafer 200 is inserted into the slot of the boat 217 free of abnormality.

In addition, numerical data of each measurement point detected by the wafer abnormality detection device 400 is displayed in the Top, Peak, and Bottom.

Here, the numerical value data of each measurement point is collectively called wafer position data 525. In comparison between the wafer status screen G1 and the wafer status screen G2, a clearly different point is the point that the wafer position data 525 is displayed in the detail-display list 512, together with the “Wafer Map” CELL 522, the “Detect Info.” Cell 523, and the “Correction” cell 524. This wafer position data 525 is of course displayed in the same screen as the boat image such as “Wafer Map” 515, “Detective Info.” 516, “Info. Correction” 517. As is clarified from the wafer status screen G2, the normal wafer 200 in the transfer state is displayed as “Normal” together with the “Detect Info.” Cell 523 and the “Correction” cell 524, and in the wafer position data 525 in this case, difference between Top and Peak, and difference between Peak and Bottom are set to be 5, respectively. However, as the numerical value of the wafer position data 525 showing the abnormal wafer, Top is 855, the Peak is 875, and the Bottom is 845, and this shows a clearly abnormal wafer.

In the wafer status screen G2, the number of the detail-display buttons 520 are drastically reduced, and the detail-display list 521 is displayed in an empty area on the obtained screen. Therefore, it is possible to obtain an easy-to-view screen excellent in operability, compared with the wafer status screen G1. In addition, when the detail-display buttons 520 are disposed in a vertical arrangement between the boat image view and the detail-display list 521, collation between the information of the boat image view and the information of the detail-display list 521 becomes easy, as the detail-display buttons 520.

Note that when the wafer status screen G2 is displayed, namely, when the wafer status screen G2 is opened, it may also be preferable to perform programming to select the detail display button 520, so that the detail-display list 521 including the abnormal wafer can be displayed. This makes it possible to improve reliability as a system, because when the abnormal wafer exists, attention of the operator is invited simultaneously with opening of the wafer status screen G2. Note that in the display of such an abnormal wafer, order of the slot number is prioritized.

Next, other status display of the wafer status screen G2 will be explained.

In the wafer status screen G2, “Wafer Break Detect Unit Status” cell 511, “Wafer Out Detect Unit Status (wafer jump out detection status)” cell 512, “Wafer None Confirm” (WAFER NONE confirmation display) cell 513, and “Transfer Status (display of the operation state of the wafer transfer device 125a)” cell 514 are displayed.

In addition, when the information correcting information of “Correction” of the detail-display list 521 is designated, “1 Piece Cell” radio button and “Z one Cell” radio button for selecting one or a plurality of designations are displayed. These radio buttons are displayed on the wafer status screen G2 by the display control part 336.

In “Wafer Break Detect Unit Status (wafer break detection status)” cell 511, the text of “None” or “Exist” is displayed.

“None” is displayed when the detection of the wafer abnormality detection device 400 is normal, and “Exist” is displayed when the operation of the wafer abnormality detection device 400 is abnormal and the detection of the wafer break is ended.

Either one of the “None” and “Exist” is displayed in the “Wafer Out Detect Status (wafer jump out detection status)” cell 512.

“None” is displayed in the case of a normal state, namely when no wafer jump out occurs, and “Exist” is displayed when the wafer jump out occurs.

In addition, “Clear” button is displayed at the side of “Wafer Detect Unit Status” cell 511 and “Wafer Out Detect Status” cell 512, as a cancel button capable of canceling the abnormality of the wafer abnormality detection device 400.

Note that the “Clear” button is displayed on the wafer status image G2 only when cancel of error is possible.

The “Wafer None Confirm (WAFER NONE confirmation display)” cell 513.shows a state whether or not the delete of the wafer 200 on the boat 217 is completed. When the detection of the abnormal wafer or the jump out of the wafer is detected, “None (non-completion)” is displayed, and the display of “None” is maintained until a wafer delete confirmation command on the boat 217 is completed normally. Thus, the operator is urged to watch out for this display.

The operation state of the wafer transfer device 125a is displayed in “Transfer Status (status of the operation state of the wafer transfer device 125a)” cell 514.

As the operation state, Unknown (unspecified transfer device), HomePos (home position), Homing (being homing), SD Charging (SD(side dummy wafer) charging), SDDischarging (SDdischarging), PDCharging (PD(product wafer) charging), PD Discharging (PD discharging), M1 Charging (M1 (monitor M1 wafer) charging), M1 Discharging (M1 discharging), PM Charging (P&M wafer charging), PM Discharging (P&M wafer discharging) AL Charging (all wafer charging), AL Discharging (all wafer discharging), W. Broken Check (wafer break is being detected), are displayed.

Thus, the “Wafer Break Detect Unit Status (wafer break detection status)” cell 511, “Wafer Out Detect Status (wafer jump out detection status)” cell 512, “Wafer None Confirm (wafer none confirmation display)” cell 513, “Transfer Status (display of the operation state of the wafer transfer device 125a)” cell 514 are displayed in the wafer status screen G2. Accordingly, the transfer state of the wafer 200 and the state of the wafer transfer device 125a are displayed on the same screen as the boat image view such as “Wafer Map) 515, “Detect Info.” 516, “Info. Correction” 517, etc, and the detail-display list 521, thus realizing the system having improved usability.

Next, explanation will be given for a recovery function by the aforementioned wafer status screen G2 and operation screen, and an example of a recovery operation.

When “Exit (having abnormality)” is shown in the “Wafer Break Detect Unit Status (break detection mechanism status)” cell 511 or “Exist (having abnormality)” is shown in the “Wafer Out Detect Status (wafer jump out detection status)” cell 512, recovery procedure as shown in the following (1) and (2) is executed.
(1) Case in which “Exist (having abnormality)” is shown in the “Wafer Break Detect Unit Status (break detection mechanism status)” cell 511, in the wafer status screen G2:

In this case, “Detect Retry (break detection re-execution)” button is depressed from recovery command. In the case of failing in normal operation even if the re-detection is executed, “Compulsory cancel (CLEAR)” button at the side of the “Wafer Break Detect Unit Status” cell 511 is depressed to forcibly cancel the error. After cancel, the wafer 200 is recovered to adjust the wafer transfer device 125a and the break detection mechanism.
(2) Case in which “Exist (having abnormality)” is shown in the “Wafer Out Detect Status (wafer jump out detection status)” cell 512, in the wafer status screen G2:

In this case, the wafer jump out state of the boat 217 is confirmed.

When the wafer 200 on the boat 217 is jumped out, the jump out is corrected, and “Detect Retry (break detection re-execution)” button is depressed from the recovery command.

Even when the wafer 200 is not jumped out from the boat 217, the “Detect Retry (break detection re-execution)” button is depressed from the recovery command. In the case of failing in normal operation even if the re-detection is executed, “Compulsory cancel (Clear)” button at the side of the “Wafer Out Detect Status” cell 512 is depressed to forcibly cancel the error. After canceling the error, the wafer 200 is recovered and adjustment of the wafer transfer device 125a and the break detection mechanism is performed.

A recovery command screen is displayed on the wafer status screen G2 by depressing the “Recovery Command” displayed in the operation panel 510.

FIG. 8 shows an example of the recovery command screen, including “Detect Retry” button, “Detect Result Confirm” button, “Wafer Delete Confirm” button, and “CANCEL” button.

The “Detect Retry” button is a wafer abnormality detection executing button linked to an execution program whereby the wafer transfer device 125a with a sensor S of the detection arm 401 is operated, for detecting the abnormality of the wafer 200, and the “Detect Result Confirm” button is a wafer abnormality detection result confirmation button linked to an execution program for confirming a wafer abnormality detection result.

In addition, the “Wafer Delete Confirm” button is a break detection confirmation button linked to an execution program for confirming delete of the abnormal wafer, and the cancel button is linked to an execution program for returning from the recovery command screen to the wafer status screen G2.

When the “Wafer Break Detect Unit (break detection mechanism status)” or the “Wafer Out Detect Unit (wafer jump out detection status)” show “Exist (having abnormality)”, by depressing the “Detect Retry” button on the recovery command screen first, detection is performed again for each error of the break of the wafer 200.

When the error is not solved by re-detection, error compulsory cancel of the wafer transfer device 125a is performed by depressing the “Compulsory cancel (Clear)” button.

After cancel of the error, the wafer 200 on the boat 217 is recovered, and reset of the wafer transfer device 125a and the wafer abnormality detection device 400 is performed.

Here, the reset means the setup for correctly detecting the transfer state of the wafer 200 on the boat 217, such as the setup for correctly detecting abnormality or normality of the wafer 200, corresponding to the adjustment of the detection arm 401 and the actuator, positional adjustment of the sensor S and teaching of the wafer transfer device 125a.

When there is the wafer 200, with the “Wafer Break Detect Unit Status Wafer Out Detect Status (break detection mechanism status)” cell 511 showing “None (no abnormality) and the “Wafer Out Detect Status (wafer jump out detection status)” cell 512 showing “None (no jump out)”, and the “Detect Info.” cells 516, 523 showing “Abnormal (abnormality)”, recovery is executed by the next recovery procedure.

First, the wafer break on the boat 217 and the state of the abnormal wafer such as jump out are confirmed. When there is the abnormal wafer, a “break detection result confirmation” button is depressed from the recovery command, and a result is confirmed. Then, the job is continued and the abnormal wafer and the wafer 200 in the area excluding peripheral wafers of the abnormal wafer are automatically recovered. When the recovery is finished, the job is set in the abort completion waiting state, to wait for the recovery. Then, residual abnormal wafer and peripheral wafer are recovered.

The recovery of the broken wafer and the peripheral wafer is executed by a worker or the operator.

After the broken wafer and the residual wafer are recovered, a “Wafer Correct” button displayed in the operation panel 510 is depressed.

The “Wafer Correct” button is linked to the execution program for switching a screen mode of the wafer status screen G2 to an edition mode.

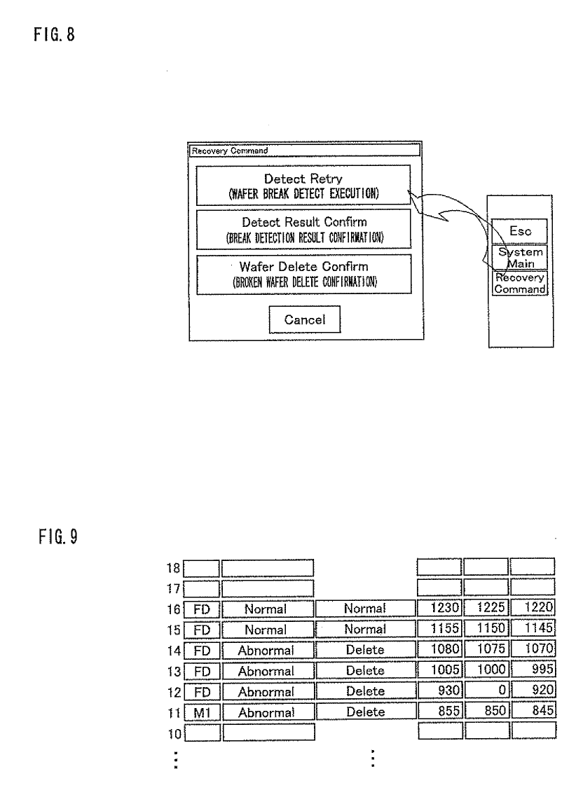

When the screen mode of the wafer status screen G2 is switched to the edition mode by depressing the “Wafer Correct” button, as shown in FIG. 9 as an expanded view, edition of the transfer information is possible by pushup of the button 524a in the “Correction” cell 524 of the detail-display list 521.

Each button 52a is linked to an information correction screen previously stored in the storage part 17.

When the transfer information (abnormality or normality) of the wafer is amended by correction, the transfer information is changed and stored in the storage part 17, and is referenced as the wafer transfer information when the next wafer status screen G2 is displayed.

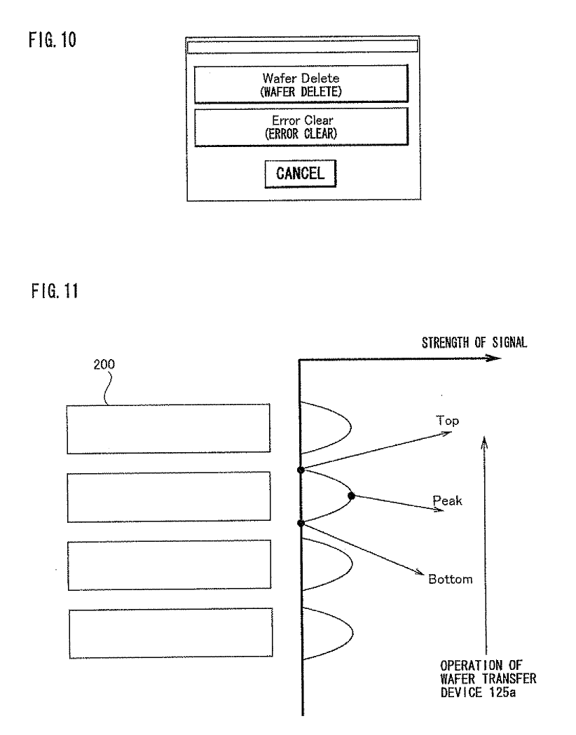

In this embodiment, by push down of the button 524a of the “Correction” cell 524, an information correction dialog of FIG. 10 is displayed.

Here, the “Wafer Delete” is selected when the wafer 200 is deleted, and “Error Clear” can be selected when transport is possible by confirmation of the operator even in a case of “Abnormal”.

After the setup of the “Wafer Delete” and “Error Clear”, by depressing a “SET” button of the wafer status screen G2, the setup is confirmed. When the setup is confirmed, the button 524a of the “Correction” cell 524 corresponding to each detailed data is set in a state of being maintained in a push down state, and the display is switched, for example, from “Abnormal” before correction to “Blank” after correction.

As a result, the display state of the wafer 200 of the boat image view coincides with the transfer state of the wafer 200 on the boat 217.

When all recovery operations are ended, “Broken wafer delete confirmation/“Wafer Delete Confirm” button is depressed from the recovery command.

When the delete confirmation is ended, the job waiting for the abort recovery is finished.

Thus, according to the wafer status screen G2 of the present invention, the transfer state of the wafer 200 and the detail-information of this wafer 200, and the status of the wafer transfer device 125a can be confirmed on the same screen, thus tremendously improving the usability.

In the wafer status screen G2, the wafer position data 525 is also displayed together with the “Wafer Map” cell 522, “Detect Info.” Cell 523, and “Correction” cell 524. Accordingly, as described before, the abnormal wafer can be easily grasped, by numerical values of the wafer position data 525. In addition, by displaying actual numerical values, basically the numerical values are invariable, when the wafer is invariable. However, the numerical values of the wafer position data 525 are changed in some cases, due to a film thickness deposited on the wafer. However, the numerical values of Top, Peak, Bottom can be confirmed on the screen, thus making it possible to manage the abnormal wafer, because the change in difference between Top and Peak (or difference between Peak and Bottom) is generated. For example, when the difference between Top and Peak (or difference between Peak and Bottom) is ±1 (4 or 6), alert (warning) is issued, and when the difference is ±2 (3 or 7), alarm (abnormality) is reported. If such a management is enabled, even when actually no WAFER NONE jump out or wafer break occurs, symptoms of these abnormalities can be grasped by managing the change of the wafer position data 525. As a result, the wafer jump out and the wafer break can be prevented before they occur.

Preferred aspects according to this embodiment will be additionally described hereunder.

### <Aspect 1>

Aspect 1 provides a substrate processing apparatus, for loading into a furnace, a substrate holding tool on which a plurality of substrates are placed and applying prescribed processing thereto, wherein a whole body of the boats is displayed in the operation screen, as a boat image view of transfer information (Dect Info 501, 516) regarding the substrates on the substrate holding tool, and the whole body of the boats is divided into a plurality of areas, so that detail-information of a substrate of each area (detail-information 504 and detail-display list 521) is switched by screen operation and displayed in the operation screen.

### <Aspect 2>

Aspect 2 provides the substrate processing apparatus according to the aspect 1, wherein the boat image view displays a color differentiated display by the kind of wafers, presence/absence of abnormality of the wafer, and a wafer display capable of correcting the information, respectively in the operation screen.

### <Aspect 3>

Aspect 3 provides the substrate processing apparatus according to the aspect 2, having a function of displaying a whole body of the wafers, with an area including an abnormal wafer selected, when a screen is opened first.

Note that as the substrate processing apparatus, the present invention is applied to an apparatus for processing a glass substrate such as an LCD apparatus, as well as a semiconductor manufacturing device.

1. A substrate processing apparatus, for loading a substrate holding tool, on which a plurality of substrates are placed, into a furnace and applying prescribed processing, comprising: the operation screen which displays a whole body of the boat as a boat image view and transfer information regarding the substrates on said substrate holding tool, wherein said whole body of the boats is divided into a plurality of areas, so that detail-information of a substrate of each area is switched by screen operation and displayed in said operation screen.

2. A substrate processing apparatus, for loading a substrate holding tool, on which a plurality of substrates are placed, into a furnace, and applying prescribed processing, comprising: the operation screen which displays a whole body of the boat as a boat image view and transfer information regarding the substrates on said substrate holding tool, wherein a transfer state of a substrate of each area and break result information are displayed on said operation screen, with the whole body of this substrate holding tool divided into a plurality of areas.

3. The substrate processing apparatus according to claim 1, wherein out of said plurality of areas, an area including a substrate in which abnormality occurs is preferentially displayed on said operation screen.

4. The substrate processing apparatus according to claim 1, wherein a recovery state of the substrate regarded as abnormal by said break detection result information is displayed on said operation screen.

5. The substrate processing apparatus according to claim 4, wherein a transfer state of a substrate on said operation screen, the break detection result information, and the recovery state of the substrate regarded as abnormal by said break detection result information are displayed on said operation screen, so as to correspond to each one of said substrates.

6. A substrate processing apparatus, for loading a substrate holding tool, on which a plurality of substrates are placed, into a furnace, and applying prescribed processing, comprising: the operation screen which displays a whole body of the boat as a boat image view of transfer information regarding the substrates on said substrate holding tool, and a recovery state in each substrate in which said abnormality occurs, is displayed in said operation screen.

7. The substrate processing apparatus according to claim 6, wherein the recovery state in each substrate in which said abnormality occurs is displayed on said operation screen.

8. The substrate processing apparatus according to claim 1, wherein numerical value data showing positions of said substrates is displayed in said operation screen, so as to correspond to each one of said substrates.

9. The substrate processing apparatus according to claim 1, wherein designation of the recovery processing is made possible so as to correspond to each one of said substrates.

10. The substrate processing apparatus according to claim 2, wherein out of said plurality of areas, an area including a substrate in which abnormality occurs is preferentially displayed on said operation screen.

11. The substrate processing apparatus according to claim 2, wherein a recovery state of the substrate regarded as abnormal by said break detection result information is displayed on said operation screen.

12. The substrate processing apparatus according to claim 2, wherein numerical value data showing positions of said substrates is displayed in said operation screen, so as to correspond to each one of said substrates.

13. The substrate processing apparatus according to claim 6, wherein numerical value data showing positions of said substrates is displayed in said operation screen, so as to correspond to each one of said substrates.

14. The substrate processing apparatus according to claim 2, wherein designation of the recovery processing is made possible so as to correspond to each one of said substrates.

15. The substrate processing apparatus according to claim 6, wherein designation of the recovery processing is made possible so as to correspond to each one of said substrates.
